(19) United States
(12) Patent Application Publication
(10) Pub. No.: US 2025/0033393 A1
(43) Pub. Date: Jan. 30, 2025

(54) PRINTING APPARATUS

(71) Applicant: CANON KABUSHIKI KAISHA, Tokyo (JP)

(72) Inventors: SHOGO NISHIE, Kanagawa (JP); YASUSHI MATSUMOTO, Tokyo (JP); GAKUSHI TANAKA, Kanagawa (JP); TAKEHIRO NAKATA, Tokyo (JP); AKIRA NAKASHIMA, Kanagawa (JP)

(21) Appl. No.: 18/778,947

(22) Filed: Jul. 20, 2024

(30) Foreign Application Priority Data
Jul. 27, 2023 (JP) 2023-122742

(51) Int. Cl. B41J 29/19; B41J 13/10; B41J 29/02; B41J 29/46

(52) U.S. Cl. CPC B41J 29/19; B41J 13/106; B41J 29/02; B41J 29/46

(57) ABSTRACT

A printing apparatus includes an apparatus body, and an operation panel attached to a front face of the apparatus body. The operation panel includes a light source provided inside the operation panel, and a light guide for causing light emitted from the light source to exit from a light exit surface provided at an edge of the operation panel, and the apparatus body has a reflecting surface that reflects the light exited from the light exit surface.

### BACKGROUND OF THE INVENTION

### Field of the Invention

The present invention relates to a printing apparatus having a function of indicating a status of the apparatus by illumination.

### Description of the Related Art

There is known an image forming apparatus having an operation panel with a light source and a light guide installed thereon, the operation panel being configured to provide illumination that enables a user to recognize the status of the apparatus and helps improve the visibility of a part that has been difficult for the user to visually recognize.

Japanese Patent Laid-Open No. 2008-268785 discloses an image forming apparatus having an operation panel whose operation surface may be tilted into alignment with a direction of a user's line of sight, causing an illumination unit provided on a back surface of the operation surface to be also tilted to automatically illuminate a predetermined position in a printing medium accommodation space. The aforementioned configuration makes the printing medium accommodation space easier for all users to visually recognize, even when users of different heights use the image forming apparatus.

The technique described in Japanese Patent Laid-Open No. 2008-268785 allows for illuminating the printing medium accommodation space when the operation panel is retracted or tilted. However, the aforementioned technique does not provide a function of enabling the user to visually recognize the current status of the image forming apparatus during, for example, image formation or occurrence of an error.

### SUMMARY OF THE INVENTION

The present invention which has been made in view of the aforementioned problem, provides a printing apparatus that can present the status of the apparatus in an easier manner for the user to visually recognize.

According to an aspect of the present invention, there is provided a printing apparatus comprising: an apparatus body; and an operation panel attached to a front face of the apparatus body, wherein the operation panel includes a light source provided inside the operation panel, and a light guide for causing light emitted from the light source to exit from a light exit surface provided at an edge of the operation panel, and the apparatus body has a reflecting surface that reflects the light exited from the light exit surface.

Further features of the present invention will become apparent from the following description of exemplary embodiments with reference to the attached drawings.

### BRIEF DESCRIPTION OF THE DRAWINGS

FIGS. 1A and 1B are perspective views illustrating the appearance of an inkjet printing apparatus according to an embodiment of the present invention.

FIG. 2 is a perspective view of a printing apparatus body.

FIG. 3 is a top view of the apparatus body having an operation panel and a first cover attached thereto.

FIG. 4 is a perspective view of a maintenance cartridge as a single body.

FIG. 5 is a cross-sectional view illustrating a main configuration of the printing apparatus.

FIGS. 6A and 6B are schematic cross-sectional views of a tilt mechanism.

FIG. 7 is a schematic view of the tilt mechanism seen from the back.

FIG. 8 illustrates a force relationship for holding a tilt position of the operation panel of the tilt mechanism.

FIG. 9 is a cross-sectional view of a panel unit when the operation panel is retracted.

FIGS. 10A to 10D are external and internal views illustrating a relation between a light source and a light guide.

FIG. 11 is a perspective view of the operation panel in a tilted state seen from below.

FIG. 12 is a front view of the printing apparatus with the operation panel removed.

FIG. 13 is an optical path diagram when the operation panel is retracted.

FIG. 14 is an optical path diagram when the operation panel is tilted.

FIGS. 15A and 15B illustrate an irradiation range of light when the operation panel is tilted.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

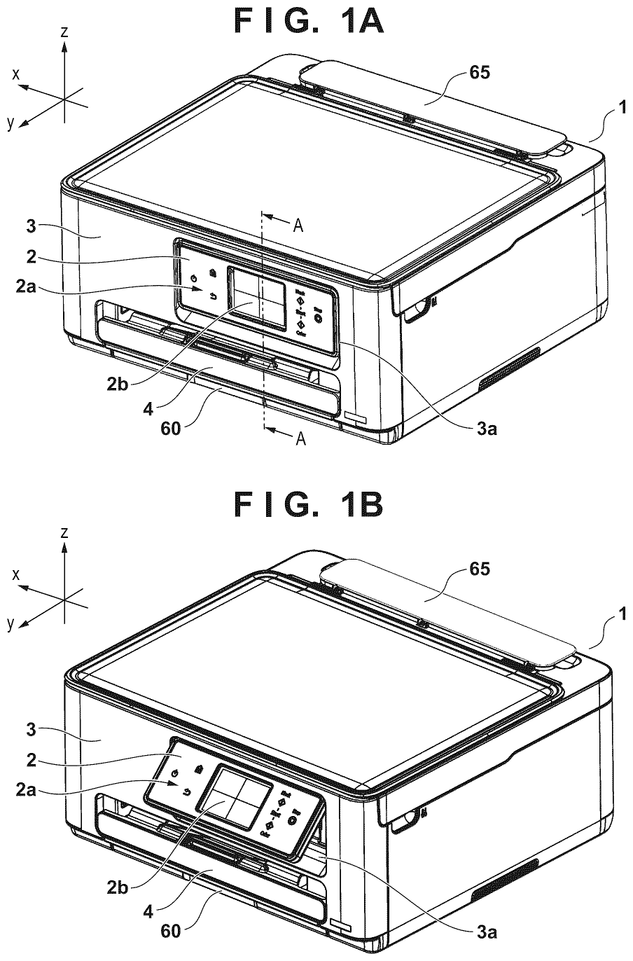

FIGS. 1A and 1B are perspective views illustrating the appearance of an inkjet printing apparatus 1 according to an embodiment of the present invention.

As illustrated in FIG. 1A, an operation panel 2 and a first cover 3 are provided on the front face of the printing apparatus 1. The first cover 3 has formed thereon a recessed portion 3a for accommodating the operation panel 2. The operation panel 2 has provided therein an operation unit 2a including an operation member for activating power supply to the printing apparatus 1, and buttons for performing various settings for forming an image on a printing medium (printing sheet). In addition, a display unit 2b for displaying the state of the printing apparatus 1, various setting items for forming an image, or the like is provided. Here, the various settings for forming an image on a printing medium may also be performed by touching the display unit 2b.

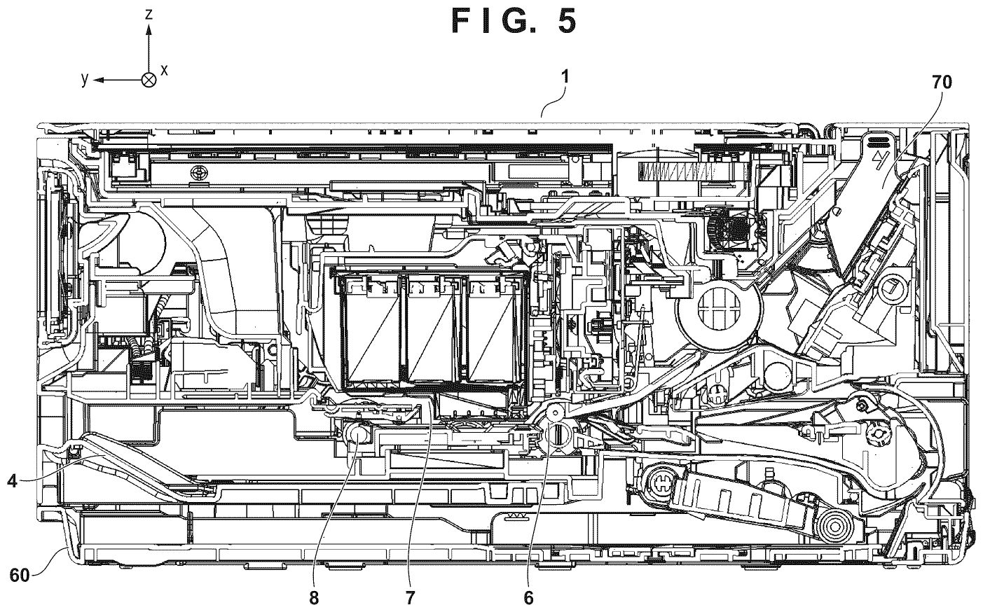

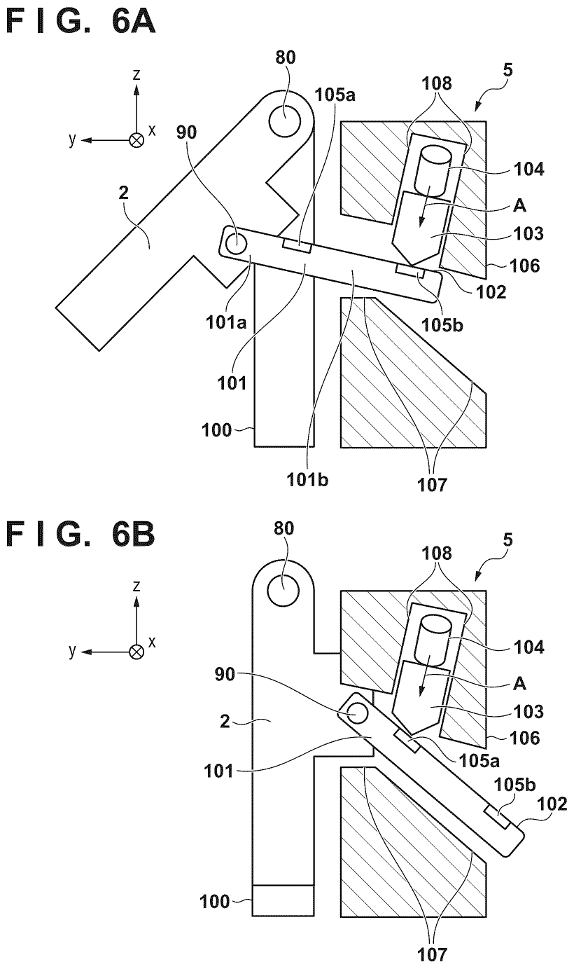

In addition, the operation panel 2 can be tilted in the vertical direction about a first rotation axis 80 (see FIGS. 6A and 6B) extending along one side of an upper end of the operation panel 2, as illustrated in FIG. 1B. The foregoing allows the user to tilt the operation panel 2, making it easier to use in accordance with the user's line of sight. In addition, there are provided, at the lower part of the front face of the printing apparatus 1, a sheet feeding cassette 60 configured to stack printing media and feed sheets for forming images, and a sheet discharge tray 4 that receives discharged printing media having images formed thereon. Here, sheets may also be fed from a second sheet feeding unit 70 (see FIG. 5) which appears by opening a third cover 65 provided at the rear upper part of the printing apparatus 1.

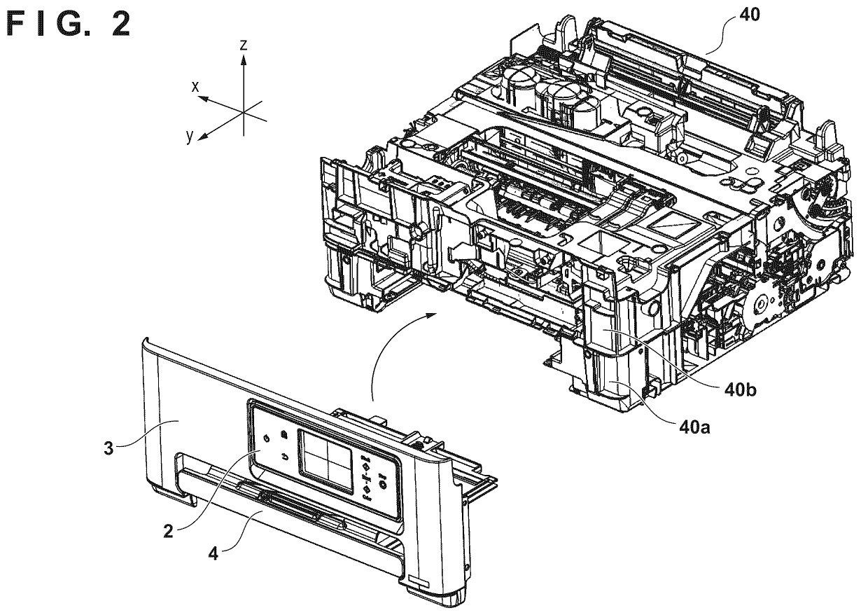

FIG. 2 is a perspective view of an apparatus body 40 including a frame forming a base of the printing apparatus 1 and various functional units performing functions such as conveyance of a printing medium and image formation. As illustrated in FIG. 2, the frame includes a first frame 40a on a lower side and a second frame 40b on an upper side, the two frames having attached thereto the operation panel 2, the first cover 3, the sheet discharge tray 4, or the like.

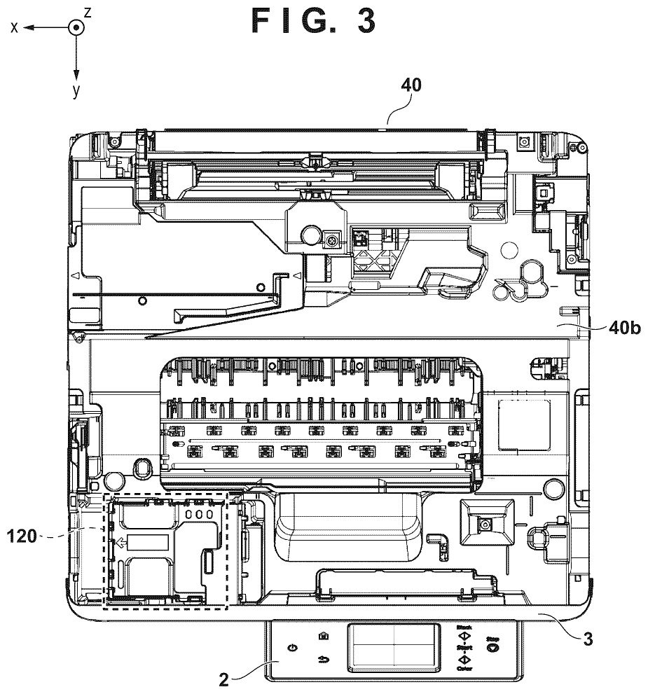

FIG. 3 is a top view of the apparatus body 40 having the operation panel 2 and the first cover 3 attached thereto. Here, the operation panel 2 is in a tilted state.

As illustrated in FIG. 3, a maintenance cartridge 120 is provided on the left front face of the apparatus body 40. The maintenance cartridge 120 has a function of receiving excess ink remaining in an ink ejection unit by causing a pump (not illustrated) to suck up the excess ink, in order to perform ink ejection for smoothly forming an image on a printing medium by an image forming unit 7 (see FIG. 5). As illustrated in FIG. 3, the operation panel 2 is located rightward of the apparatus body 40, due to the maintenance cartridge 120 being provided on the left front.

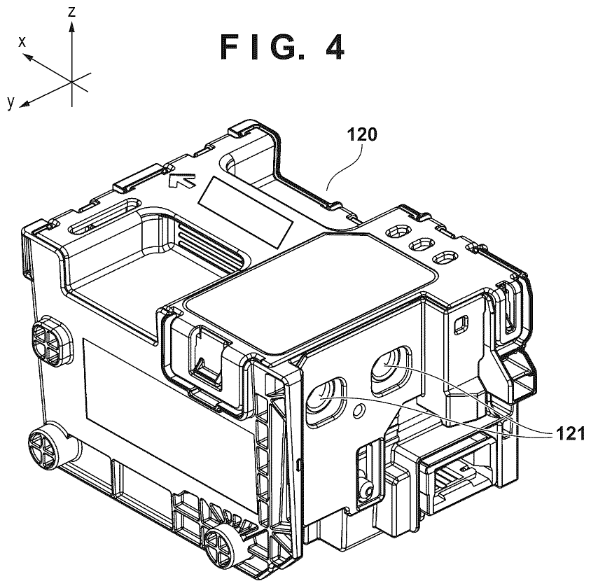

FIG. 4 is a perspective view of the maintenance cartridge 120 as a single body. As illustrated in FIG. 4, two holes 121 are formed on the side face of the maintenance cartridge 120. A tube (not illustrated) is connected to the two holes 121, and excess ink absorbed by the pump is discharged into the maintenance cartridge 120 through the tube and the holes 121. Here, a user can remove the maintenance cartridge 120 from the apparatus body 40 for replacement.

FIG. 5 is an A-A cross-sectional view of the printing apparatus 1 illustrated in FIG. 1A. Here, a main configuration of the printing apparatus 1 will be described, referring to FIG. 5.

According to FIG. 5, a printing medium is set on the sheet feeding cassette 60 or the second sheet feeding unit 70 when feeding a sheet to the printing apparatus 1. The fed printing medium is conveyed through a conveying unit 6, and an image is formed by the image forming unit 7. The printing medium having an image formed thereon passes through a sheet discharge unit 8 to be stacked on a sheet discharge tray 4 which can be drawn toward the front of the printing apparatus 1.

FIGS. 6A and 6B are schematic cross-sectional views illustrating a tilt mechanism 5 of the operation panel 2 in the present embodiment. More specifically, there is illustrated a cross-sectional view of the operation panel 2 taken along the YZ plane, illustrating a part corresponding to the tilt mechanism 5 of the operation panel 2. FIG. 6A illustrates an open state of the operation panel 2, and FIG. 6B illustrates a closed state of the operation panel 2.

With the operation unit 2a (see FIGS. 1A and 1B) or like being provided on the operation panel 2, the user's pressing of any of the buttons on the operation unit 2a causes a force to be applied in a direction closing the operation panel 2. In such a case, the tilt mechanism 5 needs to hold the operation panel 2 so that the tilt angle of the operation panel 2 does not change.

Therefore, the present embodiment supports the operation panel 2, against a hinge base 100 included the tilt mechanism 5, not only by the first rotation axis 80 which is the rotation center thereof but also by a stopper 101 at a position close to the center of the operation panel 2 (a position separated from the first rotation axis 80 by a predetermined distance toward the tip of the operation panel 2).

A tip portion (one end portion) 101a of the stopper 101 is rotatably coupled to a second rotation axis 90 provided at a position close to the center of the operation panel 2. A cam face 102 is formed on the surface of a main body 101b of the stopper 101, and the tip of a first pressing member 103 is biased toward the face of interest (in the direction indicated by an arrow A) by a first compression coil spring 104. The bias force causes the tip of the first pressing member 103 to fit into grooves 105 provided at two positions in the sliding direction of the cam face 102, and the stopper 101 stops at the positions (tilt angle 0°: 105a, tilt angle 45°: 105b) of the grooves 105. The tilt angle of the operation panel 2 is thus held.

The stopper 101, the first pressing member 103, and the first compression coil spring 104 are held by a cover member 106 fixed to the hinge base 100. The stopper 101 is guided by a first guiding surface 107 of the cover member 106 to be slidably held in the longitudinal direction. In addition, the first pressing member 103 is guided by a plurality of second guiding surfaces 108 of the cover member 106 to be slidably held in the pressing direction.

When releasing the hold of the tilt angle of the operation panel 2, the user only needs to apply a predetermined force or more to the operation panel 2. The user's applying of a force to the operation panel 2 against the bias force of the first compression coil spring 104 causes the tip of the first pressing member 103 to move along the cam face 102 to leave the groove 105 of the stopper 101, releasing the hold of the tilt angle thereby.

Holding the operation panel 2 as described above results in formation of a triangle by the first rotation axis 80, the second rotation axis 90, and the groove 105 on the cam face 102. The triangular configuration is thus proved to be stable against an external force including a case where a button operation or the like is performed while the operation panel 2 is kept open, making it possible to hold the tilt angle of the operation panel 2.

FIG. 7 is a schematic view of the tilt mechanism 5 according to the present embodiment seen from the back. The present embodiment applies, to the stopper 101, not only the bias force exerted by the first pressing member 103 but also a bias force (pressing force) in a second bias direction which is a different direction from a first bias direction (direction indicated by an arrow A in FIGS. 6A and 6B) which is a bias direction of the first pressing member 103. In the following, the second bias direction will be described.

A second pressing member 109 is in contact with a different surface from the cam face 102 on which the bias force of the first pressing member 103 of the stopper 101 acts, and biased by the second compression coil spring 111 in a direction indicated by an arrow Fc. More specifically, the second pressing member 109 is in contact with the side face 112 of the cam face 102 of the stopper 101 and presses the stopper 101 from the side face. The stopper 101, the second pressing member 109, and the second compression coil spring 111 are held by the hinge base 100 and the cover member 106. The second pressing member 109 and the second compression coil spring 111 are movable in the direction indicated by the arrow Fc, in a manner guided by the hinge base 100 and the cover member 106.

For the purpose of holding the tilt angle of the operation panel 2, a frictional force exerted by the bias force of the second pressing member 109 against the stopper 101 may also be used in addition to the bias force of the first pressing member 103 to serve as a brake against the stopper 101. As a result, it becomes possible to hold the tilt angle of the operation panel 2 even when the bias force of the first pressing member 103 is slightly weakened, whereby wear of the first pressing member 103, the stopper 101, and the second pressing member 109 can be suppressed.

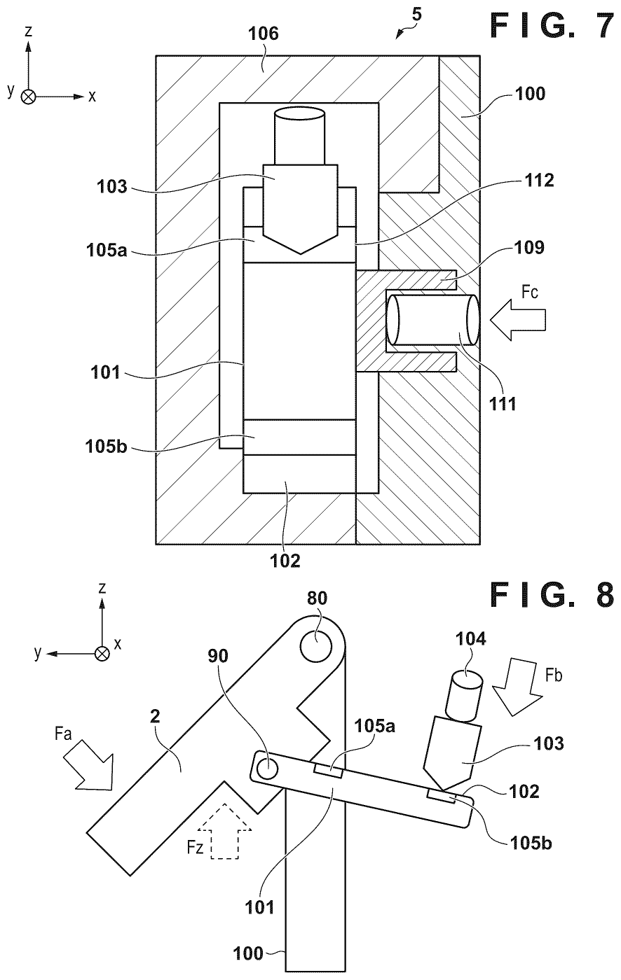

FIG. 8 illustrates a force relationship for holding a tilt position of the operation panel 2 of the tilt mechanism 5. The force Fc (see FIG. 7) applied to the stopper 101 by the second pressing member 109 exerts a frictional force between the stopper 101 and the cover member 106 that brakes the movement of the stopper 101. As a result, a force Fz supporting the operation panel 2 acts as a total force of forces Fb and Fc (see FIG. 7) provided from the first pressing member 103 and the second pressing member 109 against a force Fa applied to the operation panel 2 by an operation of any of the buttons. Accordingly, the tilt angle of the operation panel 2 can be reliably held.

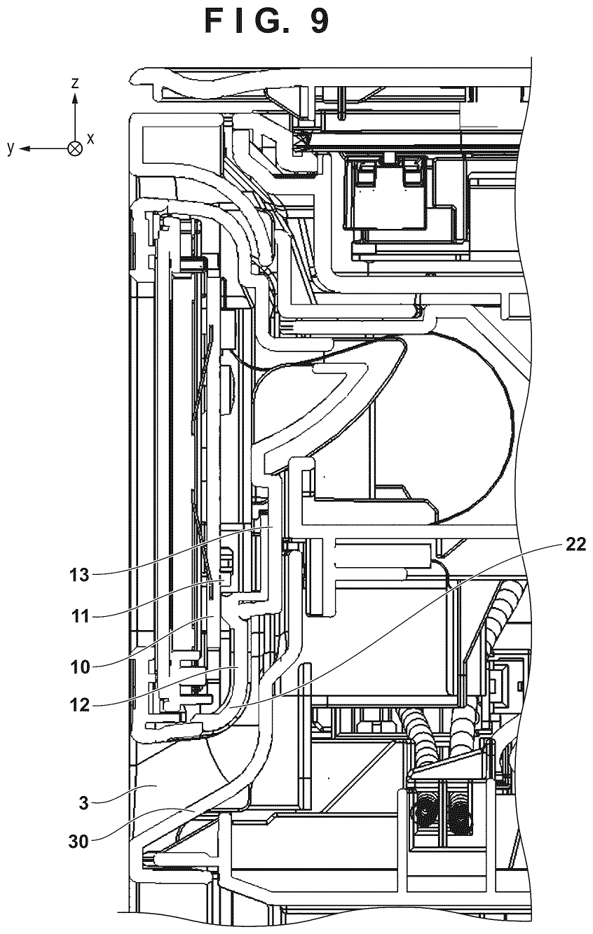

FIG. 9 is the A-A cross-sectional view illustrated in FIG. 1A when the operation panel 2 is retracted (tilt angle being 0°). As illustrated in FIG. 9, the operation panel 2 includes a substrate 10, a light source 11, a light guide 12, and a second cover 13 in which a light exit surface 22 of the light guide 12 forms a part of the appearance. The light exit surface 22 is provided on the operation panel 2 along a side opposite to the side along which the first rotation axis 80 is provided.

The substrate 10 has a flat and rectangular shape elongated in the x-direction, one side of which (rightward side in FIG. 9) includes the light source 11, and has an electric circuit provided thereon for causing the light source 11 to emit light. Additionally, as illustrated in FIG. 9, the first cover 3 has provided thereon a second reflecting surface 30 in a manner facing the light exit surface 22 in order to reflect the light irradiated from the light exit surface 22 of the light guide 12.

Here, the light source 11 serves to notify the user of the status of the printing apparatus 1 by, for example, changing an emission color, blinking, or changing the blinking pattern. The status of the printing apparatus 1 may be that of the printing apparatus 1 performing printing, waiting for printing, having run out of printing media, experiencing a paper jam, experiencing other types of errors, or the like. The user can know the status of the printing apparatus 1 from the color or state of the light emitted by the light source 11.

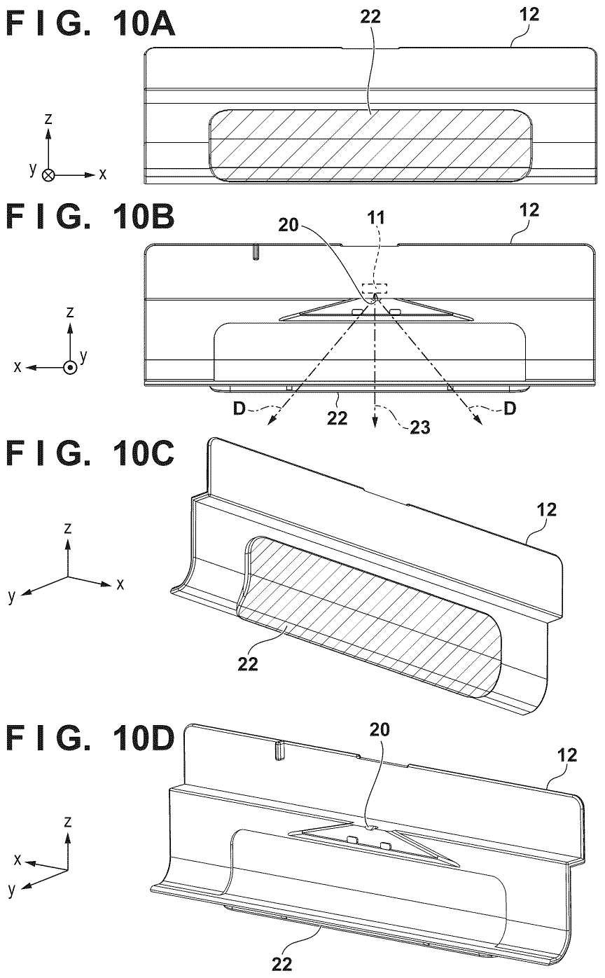

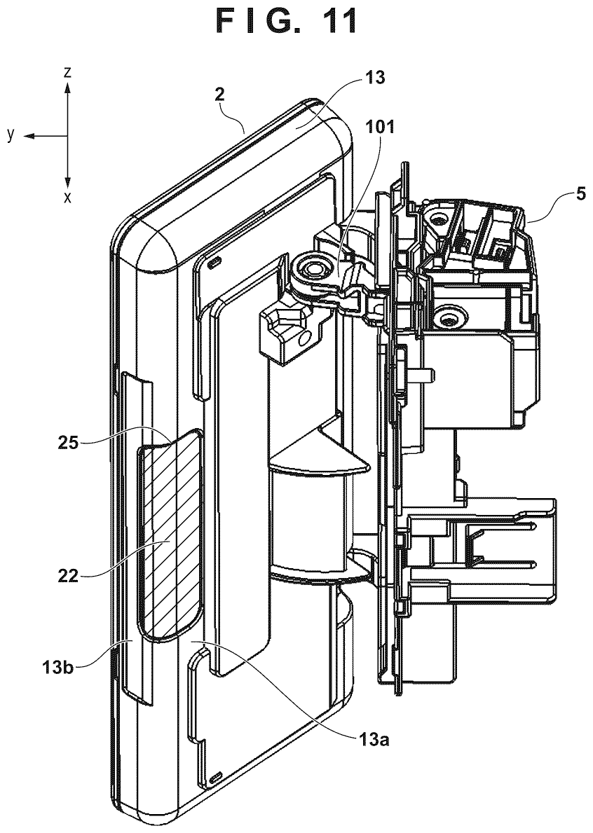

FIGS. 10A to 10D are external and internal views illustrating the relation between the light source 11 and the light guide 12. FIG. 10A is an external view. The hatched surface is the light exit surface 22, with an exterior surface being exposed from an opening 25 (see FIG. 11) of the second cover 13. FIG. 10B is an internal view illustrating the relation between the light source 11 and the light guide 12. As illustrated in FIG. 10B, the light guide 12 includes a spherical light receiving surface 20 at the same position in the x-direction as the light source 11 provided on the operation panel 2 and at a position immediately below the light source 11 (near the center of the light guide 12 in its width direction). The light guide 12 takes the light beam 23 emitted from the light source 11 into the light guide 12 through the light receiving surface 20, and diffuses the light beam 23 in each direction inside the light guide 12 as indicated by an arrow D. Here, the light guide 12 is formed of a milky white resin such as polystyrene (PS) having a high transparency.

FIG. 10C is a perspective view of the light guide seen from the outside. FIG. 10D is a perspective view of the light guide seen from the inside. The light exit surface 22 is convex outward. The light receiving surface 20 is provided inward.

FIG. 11 is a perspective view of the operation panel 2 seen from below when it is tilted at a tilt angle of 45°. As illustrated in FIG. 11, the opening 25 is formed from the front face 13a to a part of the bottom 13b of the second cover 13. The light exit surface 22 (hatched range in FIG. 11) of the light guide 12 is exposed from the opening 25 as an external surface, and light is irradiated from the light exit surface 22.

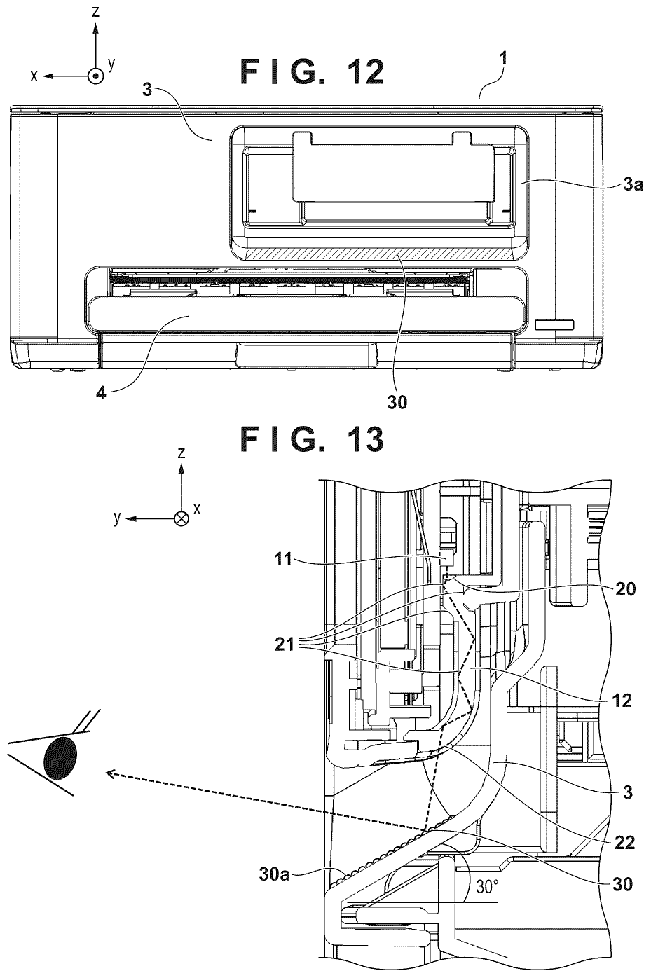

FIG. 12 is a front view of the printing apparatus 1 with the operation panel 2 removed to indicate the range of the first cover 3. Here, the internal configuration of the printing apparatus 1 visually recognized by removing the operation panel 2 is omitted for ease of understanding the range of the first cover 3. The hatched range in FIG. 12 is the range of the second reflecting surface 30 of the first cover 3 described above. The second reflecting surface 30 is longer than the light exit surface 22 in the width direction of the device. The range of the second reflecting surface 30 is white-colored and includes a plurality of fine protruding shapes 30a (see FIG. 13).

FIG. 13 is the A-A cross-sectional view in FIG. 1A illustrating an example optical path along which light emitted from the light source 11 reaches the user's eyes when the operation panel 2 is retracted. The present embodiment prevents visually recognizing the light guide 12 from the front face of the apparatus when the operation panel 2 is retracted. In other words, the user cannot directly see the light from the light guide 12.

The light emitted from the light source 11 is incident on the light receiving surface 20 of the light guide 12, reflected inside the light guide 12 and subsequently exits from the light exit surface 22, is reflected by the second reflecting surface 30 of the first cover 3, and reaches the user's eyes. More specifically, the light receiving surface 20, which is formed in a spherical shape as described above, takes the incident light from the light source 11 into the light guide 12, and diffuses the light in each direction. The light diffused inside the light guide 12 is totally reflected by a plurality of first reflecting surfaces 21 existing in the light guide 12, also reflected inside a part of the light exit surface 22, and subsequently exits from the light exit surface 22.

Here, although a reflection angle and a refraction angle of the light incident on the first reflecting surface 21 and the light exit surface 22 in the light guide 12 change in accordance with a refractive index determined by the materials inside and outside the surfaces, the light beam incident at an angle equal to or smaller than the critical angle is totally reflected, whereby the intensity of the light is maintained.

In the present embodiment, the outside of the interface is assumed to be air and a polystyrene (PS) material is used as the material of the light guide 12, whereby the critical angle becomes approximately 39° based on respective refractive indices. Therefore, as illustrated in FIG. 13, the light incident on the first reflecting surface 21 and the light exit surface 22 at an incident angle equal to or larger than 39° in the light guide repeats being totally reflected, is incident on the light exit surface 22 at an incident angle smaller than the critical angle while maintaining the intensity, and exits from the light exit surface 22.

The exited light is irradiated on the second reflecting surface 30 of the first cover 3 forming an angle of 30° with respect to the xy plane, and the light reflected by the second reflecting surface 30 eventually reaches the user's eyes. Here, the reflecting surface 30 may be at another angle, which is preferable an angle that deviates further away from the light guide 12 at positions closer to the front face of the apparatus. As has been described above, the second reflecting surface 30 is white-colored and has a plurality of fine protruding shapes 30a. The light irradiated from the light exit surface 22 hits the fine protrusion shape 30a of the second reflecting surface 30, thereby improving the light diffusivity. The user can indirectly view the light reflected by the second reflecting surface 30 to recognize the status of the printing apparatus 1 from the color and state of the light.

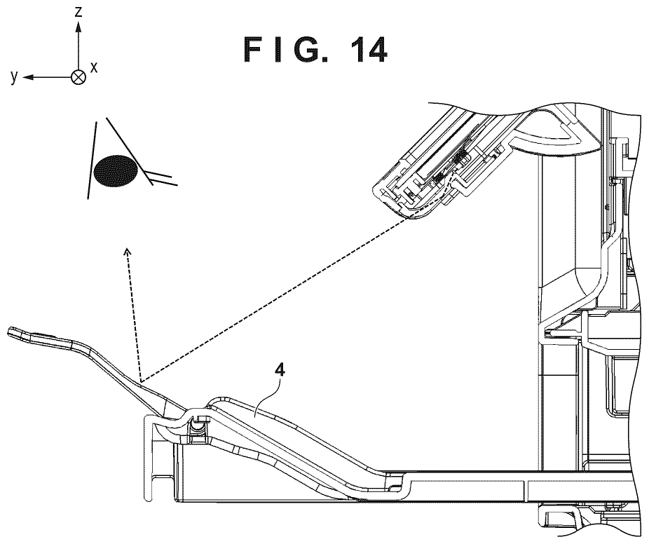

FIG. 14 is the A-A cross-sectional view in FIG. 1A, illustrating an example optical path when the operation panel 2 is tilted. As illustrated in FIG. 14, the light exited from the light exit surface 22 of the light guide 12 is irradiated on the sheet discharge tray 4 drawn from the printing apparatus 1 when the operation panel 2 is tilted. As a result, the user can also recognize the status of the printing apparatus 1 by viewing the reflected light from the surface of the printing media stacked on the sheet discharge tray 4. Depending on the angle of the operation panel 2, the user can recognize a part of the light guide from the front. However, the light traveling toward the front of the printing apparatus includes more reflected light than direct light.

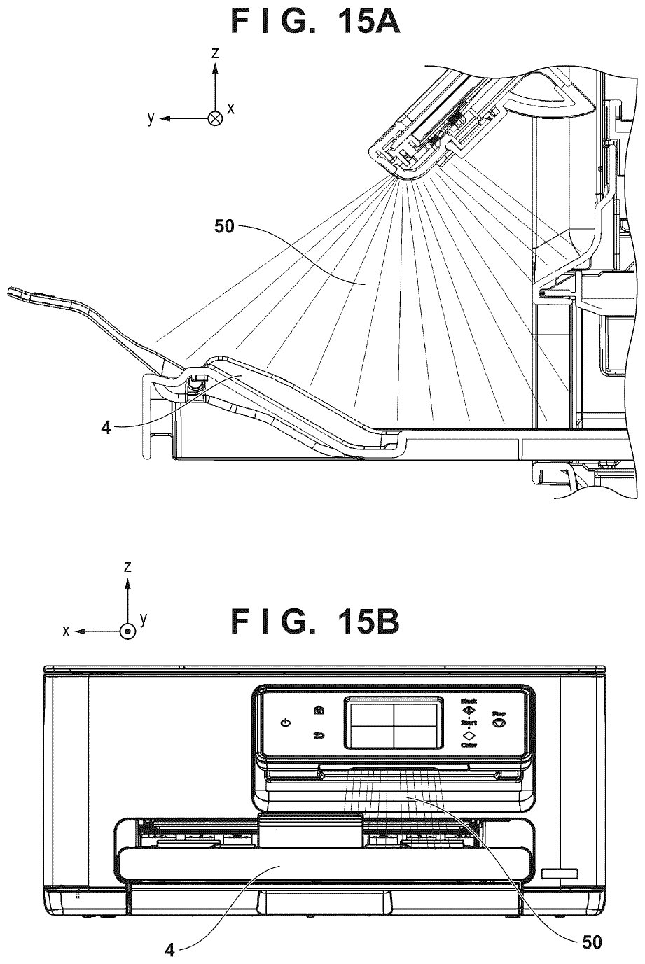

FIGS. 15A and 15B illustrate an irradiation range 50 of light when the operation panel 2 is tilted. FIG. 15A illustrates the irradiation range seen from the x-direction, and FIG. 15B illustrates the irradiation range seen from the front of the apparatus.

As illustrated in FIGS. 13 to 15A and 15B, the user can recognize the status of the printing apparatus 1 by indirectly visually recognizing the reflected light of the light emitted from the light source 11 in two modes: the operation panel 2 being retracted (tilt angle being 0°) and tilted (e.g., tilt angle being 45°).

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-122742, filed Jul. 27, 2023, which is hereby incorporated by reference herein in its entirety.

What is claimed is:

1. A printing apparatus comprising:
an apparatus body; and
an operation panel attached to a front face of the apparatus body, wherein
the operation panel includes a light source provided inside the operation panel, and a light guide for causing light emitted from the light source to exit from a light exit surface provided at an edge of the operation panel, and
the apparatus body has a reflecting surface that reflects the light exited from the light exit surface.

2. The printing apparatus according to claim 1, wherein the operation panel is provided to be tiltable with respect to the apparatus body about one side of the operation panel, and the light exit surface is provided on another side opposite to the one side.

3. The printing apparatus according to claim 2, wherein the operation panel is tiltable in a vertical direction about the one side on an upper side.

4. The printing apparatus according to claim 2, wherein the light exit surface is formed across the other side of the operation panel and a side face of the operation panel.

5. The printing apparatus according to claim 1, wherein the apparatus body has a recessed portion that accommodates the operation panel.

6. The printing apparatus according to claim 5, wherein the reflecting surface is diagonally provided at a position facing the light exit surface of the recessed portion.

7. The printing apparatus according to claim 1, further comprising a sheet discharge tray that is provided on a lower side of the front face of the apparatus body and can be drawn from the apparatus body.

8. The printing apparatus according to claim 7, wherein the operation panel is configured so that the light exited from the light exit surface is irradiated on the sheet discharge tray when the operation panel is tilted with respect to the apparatus body.

9. The printing apparatus according to claim 1, wherein the light guide has a light receiving surface that receives light emitted from the light source.

10. The printing apparatus according to claim 1, wherein the light guide has a plurality of surfaces that totally reflect the light emitted from the light source inside the light guide.

11. The printing apparatus according to claim 1, wherein the reflecting surface is white-colored and has a plurality of protruding shapes.

12. The printing apparatus according to claim 1, wherein the light source is provided near a center in a width direction of the light guide.

13. The printing apparatus according to claim 1, wherein the light guide is formed of a milky white material having a high transparency.

14. The printing apparatus according to claim 1, wherein the light source notifies a user of a status of the printing apparatus by changing an emission color.

15. The printing apparatus according to claim 1, wherein the light source notifies a user of a status of the printing apparatus by blinking.
